(19) United States
(12) Patent Application Publication
(10) Pub. No.: US 2024/0413578 A1
(43) Pub. Date: Dec. 12, 2024

(54) FLOATING POWER SUPPLY CONNECTING ASSEMBLY

(71) Applicants: JIANGJUAN LIN, Ningbo (CN); HUANLE XIA, Ningbo (CN)

(72) Inventors: JIANGJUAN LIN, Ningbo (CN); HUANLE XIA, Ningbo (CN)

(73) Assignee: NINGBO WELLDON INFANT AND CHILD SAFETY TECHNOLOGY, Ningbo (CN)

(21) Appl. No.: 18/810,547

(22) Filed: Aug. 21, 2024

(30) Foreign Application Priority Data
Jan. 14, 2024 (CN) 202420086786.2

(51) Int. Cl. H01R 13/631; H01R 13/62

(52) U.S. Cl. CPC H01R 13/6315; H01R 13/6205

(57) ABSTRACT

A floating power supply connecting assembly includes an upper connecting assembly and a lower connecting assembly. The lower connecting assembly can be a base/supporting frame. The upper connecting assembly is a replaceable hanging basket/seat. The lower connecting assembly includes a lower connecting piece, a first electric shock connector, and a first magnet. One end of the first electric shock connector is connected to the lower connecting piece, and the other end is connected to the first magnet. The upper connecting assembly includes an upper connecting piece, a second electric shock connector, and a second magnet. One end of the second electric shock connector is connected to the upper connecting piece, and the other end is connected to the second magnet. The first electric shock connector is connected to the second electric shock connector. The first magnet is connected to the second magnet.

### CROSS-REFERENCE TO RELATED APPLICATIONS

The application claims priority of Chinese patent application CN2024200867862, filed on Jan. 14, 2024, which is incorporated herein by reference in its entireties.

### TECHNICAL FIELD

The present disclosure relates to the field of seat technologies, and in particular to, a floating power supply connecting assembly.

### BACKGROUND OF THE INVENTION

In the prior art, in addition to the sitting and leaning requirements of a seat itself, additional technologies mounted on the seat have become increasingly common, such as a massage function and an electric shading function added to the seat. These convenient additional technologies usually require circuit connection. In some cases, a user has a requirement for partially replacing the seat. However, lines of the seat are basically designed, mounted, and managed uniformly, making it more complicated and almost impossible to partially replace seats with lines, and line changes increase the unsafety of the seats. This is the same as a hanging basket.

In summary, the partial replacement of the seats/hanging baskets with the lines in the prior art is complex and dangerous, making it difficult to meet the need of the user for the partial replacement of the seat. Therefore, this needs to be further improved.

### SUMMARY OF THE INVENTION

In view of this, the present disclosure provides a floating power supply connecting assembly, which can improve the convenience and safety of partial replacement of a seat/hanging basket with lines, so that a need of a user for partial replacement of the seat/hanging basket is possibly achieved.

A floating power supply connecting assembly provided by the present disclosure uses the following technical solution:

A floating power supply connecting assembly includes an upper connecting assembly and a lower connecting assembly; the lower connecting assembly can be a base/supporting frame; the upper connecting assembly is a replaceable hanging basket/seat; the lower connecting assembly includes a lower connecting piece, a first electric shock connector, and a first magnet; one end of the first electric shock connector is connected to the lower connecting piece, and the other end is connected to the first magnet; the upper connecting assembly includes an upper connecting piece, a second electric shock connector, and a second magnet; one end of the second electric shock connector is connected to the upper connecting piece, and the other end is connected to the second magnet; the first electric shock connector is connected to the second electric shock connector, so that the upper connecting assembly is connected to the lower connecting assembly through a line; and the first magnet is connected to the second magnet, so that a connection position between the first electric shock connector and the second electric shock connector is stable.

By the adoption of the above technical solution, a worker divides a seat into a base/supporting frame portion and a hanging basket/seat portion. A user arranges a branch that is in line connection to the base/supporting frame on the first electric shock connector; the lower connecting piece is a part of the base/supporting frame, and the upper connecting piece is a part of the hanging basket/seat. The base/supporting frame and the hanging basket/seat are mechanically connected to the upper connecting piece through the lower connecting piece, and the base/supporting frame and the hanging basket/seat are in line connection through the first electric shock connector and the second electric shock connector; the first magnet and the second magnet improve the stationarity and stability of connection positions of the first electric shock connector and the second electric shock connector; and if a user intends to replace the hanging basket/seat, the mechanical connection between the base/supporting frame and the hanging basket/seat is cut off, a line between the base/supporting frame and the hanging basket/seat is conveniently cut off by separating the first electric shock connector from the second electric shock connector, so that the user can easily replace another hanging basket/seat. The separation of the first electric shock connector from the second electric shock connector isolates complex methods such as circuit removal, and the first magnet and the second magnet limit connection points of the first electric shock connector and the second electric shock connector, thereby reducing connection misalignment, electrical sparks caused by the connection misalignment, and the like.

Preferably, a first protrusion is arranged on the lower connecting piece; the first electric shock connector is located at the first protrusion; a second through slot is provided on the upper connecting piece; the second through slot corresponds to the first protrusion; the second electric shock connector is arranged at the second through slot; the first protrusion of the lower connecting piece is connected to the second through slot of the upper connecting piece; and the first electric shock connector is connected to the second electric shock connector.

By adoption of the above technical solution, the upper connecting assembly and the lower connecting assembly are quickly positioned through the first protrusion of the lower connecting piece and the second through slot of the upper connecting piece, so that after a user places a hanging basket/seat for replacement on the base/supporting frame, and the second through slot cooperates with the first protrusion, the second electric shock connector in the second through slot can cooperate with the first electric shock connector on the first protrusion, thereby achieving circuit connection and improving the convenience of connecting the hanging basket/seat to the base/supporting frame.

Preferably, magnet slots are provided on two sides of the first electric shock connector and the second electric shock connector; the first magnet and the second magnet are both located in the magnet slots, so that an exposed surface of the first magnet/second magnet is on the same horizontal plane as a surface of the first electric shock connector/second electric shock connector where the first magnet/second magnet is located; and the first magnet is connected to the second magnet.

By the adoption of the above technical solution, the exposed surface of the first magnet/second magnet is located on the same horizontal plane as the surface of the first electric shock connector/second electric shock connector, so that the first magnet and the second magnet are closely connected, and the first electric shock connector and the second electric shock connector are closely connected too. Furthermore, the magnet slot ensures the stability of the positions of the first magnet and the second magnet, so that the connection positions of the first magnet and the second magnet are fixed, and the connection positions of the first electric shock connector and the second electric shock connector are fixed; the circuit stability of the first electric shock connector and the second electric shock connector is good; and electric sparks or injury to users caused by mutual movement and poor contact are avoided.

Preferably, the upper connecting piece is provided with a circuit board on the second through slot; the second electric shock connector is connected to the circuit board; the upper connecting piece is provided with a press member on the circuit board; the press member is elastic; and the press member is configured to compress the circuit board downwards, so that the first electric shock connector and the second electric shock connector are closely connected.

By the adoption of the above technical solution, the connection between the second electric shock connector and a circuit board is conducive to limiting the position of the second electric shock connector, and the connection between the second electric shock connector and the circuit board makes lines on the hanging basket/seat mounted intensively, and is conducive to reducing an area where a person in the seat is in contact with the lines, thereby increasing the safety of the seat. Moreover, the press member is configured to compress the circuit board downwards, so that the first electric shock connector and the second electric shock connector are closely connected, which improves a line connection state of the hanging basket/seat after replacement. The elastic press member has good deformability, which is not only conducive to prolonging its own service life, but also conducive to protecting the integrity of the circuit board.

Preferably, the press member is a long curved uniform strip with an arc.

By the adoption of the above technical solution, the press member presses the circuit board through the uniformly long-strip arc-shaped portion, which is conductive to protecting the integrity of the circuit board. The arc is in contact with the circuit board point, which is beneficial for reducing an affected area of the circuit board. The arc further facilitates observation and control of its compression on the circuit board, and the arc-shaped long strip has good deformability.

Preferably, the upper connecting piece is provided with a straight bar stopper on the second through slot; and the straight bar stopper is configured to reduce a contact area between the second through slot of the upper connecting piece and the first protrusion of the lower connecting piece.

By the adoption of the above technical solution, the straight bar stopper has a large bottom area, which makes it highly stable on the upper connecting piece. The straight bar stopper further has the characteristic of one side being short, so that a contact area between the second through slot of the upper connecting piece and the first protrusion of the lower connecting piece is smaller. It can not only limit the first protrusion, but also has high stability. The straight bar stopper is better than a cylindrical stopper in the prior art.

Preferably, the first electric shock connector and the second electric shock connector each include an electric shock base and a plug pin; the plug pin is connected to the electric shock base; one end of the first electric shock connector is provided with a second protrusion at the plug pin; one end of the second electric shock connector is provided with a groove at the plug pin; the groove cooperates with the second protrusion, so that the plug pin of the second protrusion is connected to the plug pin in the groove; and a diameter of the plug pin at one end of the first electric shock connector close to the second electric shock connector is greater than a diameter of the plug pin at one end of the second electric shock connector close to the first electric shock connector.

By the adoption of the above technical solution, due to the arrangement of the second protrusion and groove on the first electric shock connector and the second electric shock connector, on the one hand, it further increases the convenience of determining the connection positions of the first electric shock connector and the second electric shock connector, so that the stability of line connection is basically determined by the connection between the second protrusion and the groove. On the other hand, “hiding” points for line connection at the plug pins by the second protrusion and the groove is conducive to isolating a user from a dangerous line connection position and reducing the contact between the line connection position and a flammable material. The diameter of the plug pin at one end of the first electric shock connector close to the second electric shock connector is greater than a diameter of the plug pin at one end of the second electric shock connector close to the first electric shock connector, so that it is conductive to improving the convenience of connection with the plug pins.

Preferably, third protrusions are arranged on circumferential walls of the first electric shock connector and the second electric shock connector.

By the adoption of the above technical solution, a user can perform limited connection on the first electric shock connect/second electric shock connector through the third protrusion, which is conductive to mounting and limiting the first electric shock connect/second electric shock connector without affecting the plug pins.

Preferably, an end portion of the plug pin at one end of the first electric shock connector close to the second electric shock connector is located on the same horizontal plane as an end portion of the first electric shock connector.

By the adoption of the above technical solution, connection between a flat plug pin and a raised plug pin is more convenient that connection between raised plug pins.

Preferably, positions of the first electric shock connector and the second electric shock connector are interchangeable.

By the adoption of the above technical solution, the function of the first electric shock connector is the same as that of the second electric shock connector, to connect lines and transmit signals, so interchanging their positions will have no impact.

In summary, the present disclosure includes at least one of the following beneficial effects:

The base/supporting frame and the hanging basket/seat are mechanically connected to the upper connecting piece through the lower connecting piece, and the base/supporting frame and the hanging basket/seat are in circuit connection through the first electric shock connector and the second electric shock connector; and the first magnet and the second magnet improve the stationarity and stability of connection positions of the first electric shock connector and the second electric shock connector. The separation of the first electric shock connector from the second electric shock connector isolates complex methods such as circuit removal, and the first magnet and the second magnet limit connection points of the first electric shock connector and the second electric shock connector, thereby reducing connection misalignment, electrical sparks caused by the connection misalignment, and the like.

After the second through slot cooperates with the first protrusion, the second electric shock connector in the second through slot can cooperate with the first electric shock connector on the first protrusion, thereby achieving circuit connection and improving the convenience of connecting the hanging basket/seat to the base/supporting frame. The press member is configured to compress the circuit board downwards, so that the first electric shock connector and the second electric shock connector are closely connected.

The straight bar stopper has a large bottom area, which makes it stable on the upper connecting piece. The straight bar stopper further has the characteristic of one side being short, so that a contact area between the second through slot of the upper connecting piece and the first protrusion of the lower connecting piece is smaller. It can not only limit the first protrusion, but also has high stability.

Due to the arrangement of the second protrusion and groove on the first electric shock connector and the second electric shock connector, on the one hand, it further increases the convenience of determining the connection positions of the first electric shock connector and the second electric shock connector, so that the stability of line connection is basically determined by the connection between the second protrusion and the groove. On the other hand, “hiding” points for line connection at the plug pins by the second protrusion and the groove is conducive to isolating a user from a dangerous line connection position and reducing the contact between the line connection position and a flammable material. The diameter of the plug pin at one end of the first electric shock connector close to the second electric shock connector is greater than a diameter of the plug pin at one end of the second electric shock connector close to the first electric shock connector, so that it is conductive to improving the convenience of connection with the plug pins.

### BRIEF DESCRIPTION OF DRAWINGS

FIG. 1 is a schematic structural diagram of a lower connecting piece in this embodiment;

FIG. 2 is a schematic structural diagram of an upper connecting piece in this embodiment;

FIG. 3 is a schematic structural diagram of a first electric shock connector and a first magnet in this embodiment;

FIG. 4 is a schematic structural diagram of a first electric shock connector in this embodiment;

FIG. 5 is a schematic structural diagram of a second electric shock connector in this embodiment;

FIG. 6 is a schematic structural diagram of a second electric shock connector and a second magnet in this embodiment;

FIG. 7 is a schematic structural diagram of a circuit board in this embodiment; and

FIG. 8 is a schematic structural diagram of a connecting assembly in this embodiment.

### DETAILED DESCRIPTION OF THE INVENTION

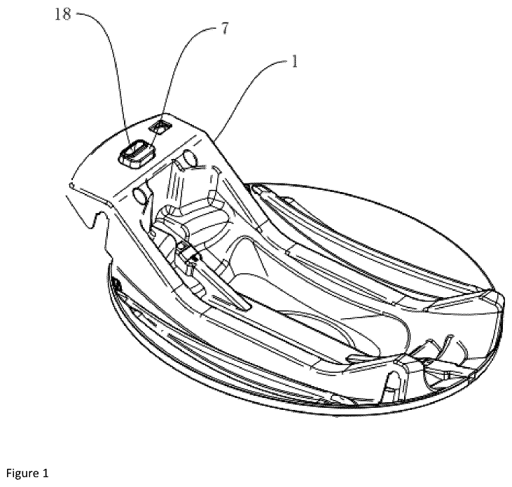

The present disclosure will be further described in detail below in conjunction with FIG. 1 to FIG. 8.

The embodiments of the present disclosure disclose a floating power supply connecting assembly,
including an upper connecting assembly and a lower connecting assembly. The lower connecting assembly can be a base/supporting frame; the upper connecting assembly can be a hanging basket/seat. The base/supporting frame has functions such as moving and supporting. The hanging basket/seat mainly provides an accommodating space and an engineering structure suitable for a human body/object. The upper connecting assembly is connected to the lower connecting assembly, so that lines between the upper connecting assembly and the lower connecting assembly are connected. Through the convenient line connection between the upper connecting assembly and the lower connecting assembly, the upper connecting assembly and the lower connecting assembly can be easily removed and replaced, thereby lowering the risk of line connection during the replacement.

The lower connecting assembly includes a lower connecting piece 1, a first electric shock connector 2, and a first magnet 3. The first electric shock connector 2 is clamped to the lower connecting piece 1, so that the first electric shock connector 2 is stably located on the lower connecting piece 1. The first magnet 3 is glued to an upper surface of the first electric shock connector 2, so that a surface of the first magnet 3 that is exposed outside is located on the same horizontal plane as a surface of an end portion of the first electric shock connector 2. The upper connecting assembly includes an upper connecting piece 4, a second electric shock connector 5, and a second magnet 6. The second electric shock connector 5 is clamped to the upper connecting piece 4, so that the second electric shock connector 5 is stably located at a position of the upper connecting piece 4. The second magnet 6 is glued to a lower side of the second electric shock connector 5, so that an end portion of the second magnet 6 exposed outside is located on the same horizontal plane as a surface of the second electric shock connector 5 on a circumferential side of the second magnet. When the first magnet 3 attracts the second magnet 6, the first electric shock connector 2 is in line connection to the second electric shock connector 5. Furthermore, due to the mutual action of magnetic poles, magnetic suction positions will be automatically adjusted, so that positions of the first magnet 3 and the second magnet 6 are fixed, and connection positions of the first electric shock connector 2 and the second electric shock connector 5 are fixed too. The separation of the first electric shock connector 2 from the second electric shock connector 5 isolates complex methods such as circuit removal, and the first magnet 3 and the second magnet 6 limit connection points of the first electric shock connector 2 and the second electric shock connector 5, thereby reducing connection misalignment, electrical sparks caused by the connection misalignment, and the like.

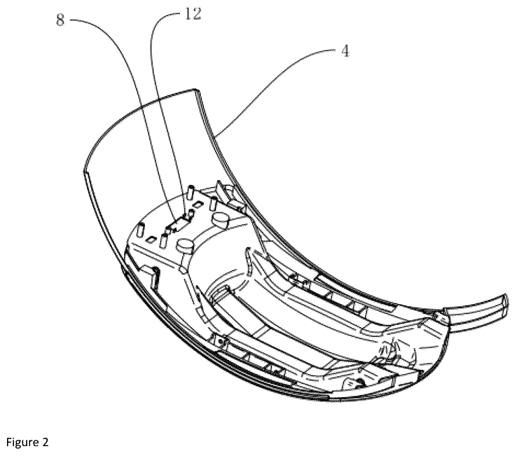

Further, in this embodiment, referring to FIG. 1 and FIG. 2, the lower connecting piece 1 is integrally connected with a first protrusion 7, and a first through slot 18 is provided on the first protrusion 7. The first electrical connector 2 is clamped into the first through slot 18, so that both upper and lower ends of the first electrical connector 2 can be seen, thereby enabling line connection at the upper and lower ends of the first electric shock connector 2. The upper connecting piece 4 is provided with a second through slot 8. The second through slot 8 cooperates with the first protrusion 7, so that during the connection between the upper connecting assembly and the lower connecting assembly, the first protrusion 7 and the second through slot 8 can be quickly positioned through their cooperation. The quick positioning of the first protrusion 7 and the second through slot 8 enables the first electrical connector 2 to be positioned and connected to the second electric shock connector 5, thereby increasing the convenience of line connection.

Further, in this embodiment, the upper connecting piece 4 is provided with a straight bar stopper 12 on the second through slot 8; the straight bar stopper 12 has a large bottom area, which makes it highly stable on the upper connecting piece 4. The straight bar stopper 12 further has the characteristic of one side being short, so that a contact area between the second through slot 8 of the upper connecting piece 4 and the first protrusion 7 of the lower connecting piece 1 is smaller. It can not only limit the first protrusion 7, but also has high stability.

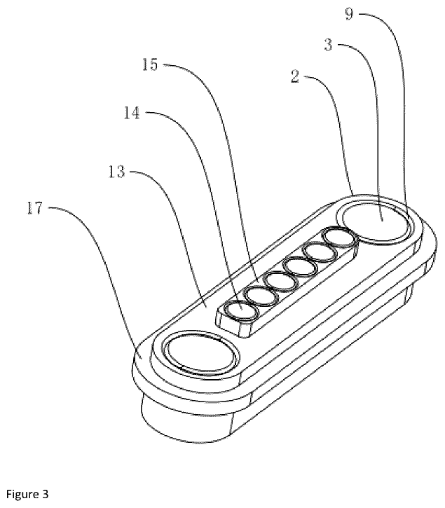

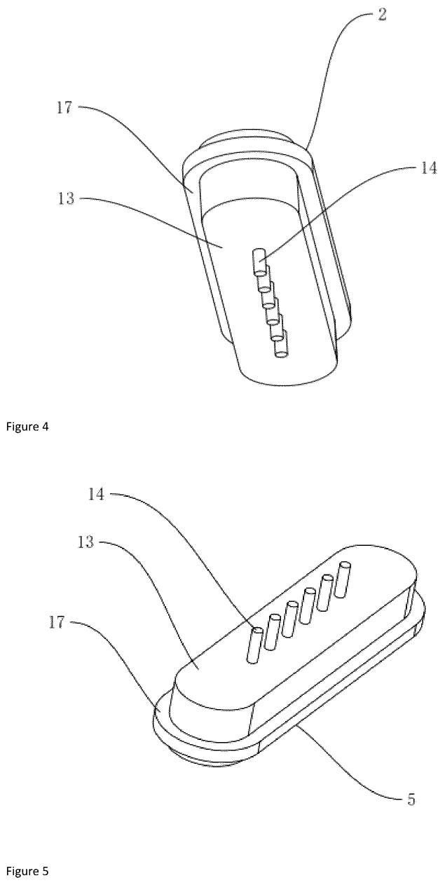

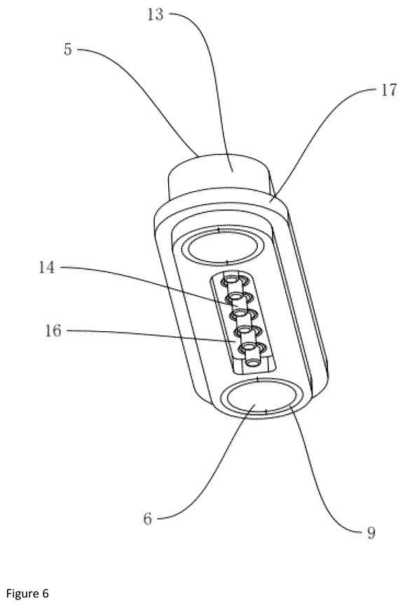

Furthermore, in this embodiment, referring to FIG. 3, FIG. 4, FIG. 5, and FIG. 6, the first electric shock connector 2 and the second electric shock connector 5 each include an electric shock base 13 and a plug pin 14; the electric shock base 13 is approximately in a shape of rounded rectangle; the plug pin 14 is integrally connected to the electric shock base 13, so that the plug pin 14 is located in the middle of the electric shock base 13; the electric shock base 13 is provided with magnet slots 9 on two sides of the plug pin 14; the first magnet 3 and the second magnet 6 are respectively glued in the magnet slots 9 of the first electric shock connector 2 and the second electric shock connector 5. The magnet slots 9 limit the stability of the positions of the first magnet 3 and the second magnet 6, so that the connection positions of the first magnet 3 and the second magnet 6 are fixed, and the end portions of the first magnet 3 and the second magnet 6 exposed outside are located on the same horizontal plane as the surfaces, on the circumferential sides of the first magnet and the second magnet, of the first electric shock connector 2 and the second electric shock connector 5. Thus, when the first magnet 3 and the second magnet 6 are in attracted connection, the plug pin 14 on the first electric shock connector 2 is connected to the plug pin 14 on the second electric shock connector 5, so that the lines of the upper connecting assembly and the lower connecting assembly are connected.

Further, in this embodiment, at one end of the first electric shock connector 2 close to the second electric shock connector 5, the electric shock base 13 is integrally connected with a second protrusion 15 on the circumferential side of the plug pin 14, and the second electric shock connector 5 is provided with a groove 16 at a position corresponding to the second protrusion 15. The groove 16 cooperates with the second protrusion 15 to make it more convenient to position the plug pin 14 in the groove 16 and the plug pin 14 on the second protrusion 15. “Hiding” points for line connection at the plug pins 14 by the second protrusion 15 and the groove 16 is conducive to isolating a user from a dangerous line connection position and reducing the contact between the line connection position and a flammable material. A diameter of an end portion of the plug pin 14 located at the second protrusion 15 is greater than a diameter of an end portion of the plug pin 14 located at the groove 16, so that it is conductive to improving the convenience of connection with the plug pins 14.

Further, in this embodiment, circumferential walls of the first electric shock connector 2 and the second electric shock connector 5 are integrally connected with third protrusions 17. By the limitation on the third protrusions 17, the first electric shock connector 2 and the second electric shock connector 5 are limited too, thereby reducing direct contact between the external world and the surfaces of both the first electric shock connector 2 and the second electric shock connector 5. This is beneficial for protecting a connecting surface of the plug pin 14 of the first electric shock connector 2 and a connecting surface of the plug pin 14 of the second electric shock connector 5 from obstacles.

Further, in this embodiment, the first electric shock connector 2 and the second electric shock connector 5 have the same functions, and the positions of the first electric shock connector 2 and the second electric shock connector 5 are interchangeable.

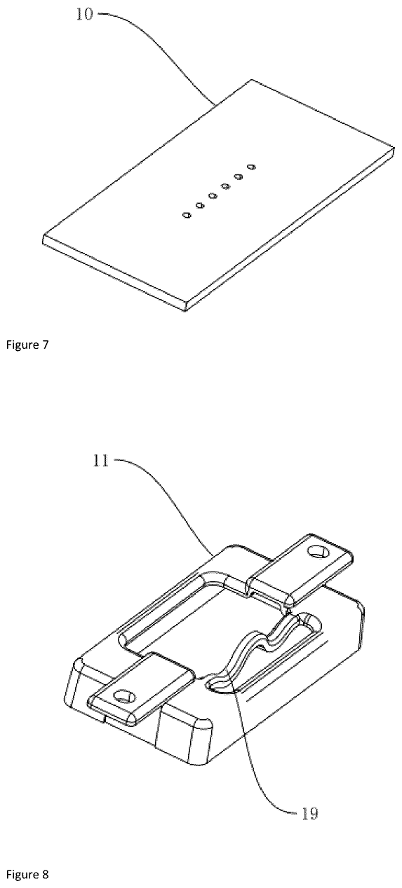

Further, in this embodiment, referring to FIG. 7 and FIG. 8, a circuit board 10 is inserted at one end of the second electric shock connector 5 away from the first electric shock connector 2. The circuit board 10 is placed at the second through slot 8, so that the second electric shock connector 5 is located in the second through slot 8, which facilitates the connection between the second electric shock connector 5 and the first electric shock connector 2. The connection between the second electric shock connector 5 and the circuit board 10 makes lines on the hanging basket/seat mounted intensively, and is conducive to reducing an area where a person in the seat is in contact with the lines, thereby increasing the safety of the seat. The upper connecting piece 4 is bolted with a press member 11. The press member 11 is a long curved uniform strip 19 with an arc. The press member 11 presses the circuit board 10 through an arc-shaped portion of the long uniform strip 19. The press member 11 is elastic. The elastic press member 11 has good deformability, which is not only conducive to prolonging its own service life, but also conducive to protecting the integrity of the circuit board 10. The arc-shaped long uniform strip 19 has good deformability too. The press member 11 can be further integrally connected with a limiting sleeve, so that the press member can protect the connecting portions of the circuit board 10 and the second electric shock connector 5 when compressing the circuit board 10 downwards.

The implementation principle of the floating power supply connecting assembly disclosed in the embodiments of the present disclosure is as follows: The upper connecting assembly integrates connected lines on the second electric shock connector 5, and the lower connecting assembly integrates branches of the connected lines on the first electric shock connector 2. The upper connecting piece 4 and the lower connecting piece 1 are connected through the first electric shock connector 2 and the second electric shock connector 5, so that the lines of the upper connecting assembly and the lower connecting assembly are connected. The first magnet 3 and the second magnet 6 on the first electric shock connector 2 and the second electric shock connector 5 are connected, and their magnetic suction positions will be automatically adjusted, so that the positions of the first magnet 3 and the second magnet 6 are fixed, thereby improving the safety of connection between the upper connecting assembly and the lower connecting assembly.

The above embodiments are only preferred embodiments of the present disclosure, and do not limit the protection scope of the present disclosure. Therefore, any equivalent changes made on the basis of the structure, shape, and principle of the present disclosure shall all fall within the protection scope of the present disclosure.

1. A floating power supply connecting assembly, comprising an upper connecting assembly and a lower connecting assembly, wherein the lower connecting assembly can be a base/supporting frame; the upper connecting assembly is a replaceable hanging basket/seat; the lower connecting assembly comprises a lower connecting piece, a first electric shock connector, and a first magnet; one end of the first electric shock connector is connected to the lower connecting piece, and the other end is connected to the first magnet; the upper connecting assembly comprises an upper connecting piece, a second electric shock connector, and a second magnet; one end of the second electric shock connector is connected to the upper connecting piece, and the other end is connected to the second magnet; the first electric shock connector is connected to the second electric shock connector, so that the upper connecting assembly is connected to the lower connecting assembly through a line; and the first magnet is connected to the second magnet, so that a connection position between the first electric shock connector and the second electric shock connector is stable.

2. The floating power supply connecting assembly according to claim 1, wherein a first protrusion is arranged on the lower connecting piece; the first electric shock connector is located at the first protrusion; a second through slot is provided on the upper connecting piece; the second through slot corresponds to the first protrusion; the second electric shock connector is arranged at the second through slot; the first protrusion of the lower connecting piece is connected to the second through slot of the upper connecting piece; and the first electric shock connector is connected to the second electric shock connector.

3. The floating power supply connecting assembly according to claim 1, wherein magnet slots are provided on two sides of the first electric shock connector and the second electric shock connector; the first magnet and the second magnet are both located in the magnet slots, so that an exposed surface of the first magnet/second magnet is on the same horizontal plane as a surface of the first electric shock connector/second electric shock connector where the first magnet/second magnet is located; and the first magnet is connected to the second magnet.

4. The floating power supply connecting assembly according to claim 2, wherein the upper connecting piece is provided with a circuit board on the second through slot; the second electric shock connector is connected to the circuit board; the upper connecting piece is provided with a press member on the circuit board; the press member is elastic; and the press member is configured to compress the circuit board downwards, so that the first electric shock connector and the second electric shock connector are closely connected.

5. The floating power supply connecting assembly according to claim 4, wherein the press member is a long curved uniform strip with an arc.

6. The floating power supply connecting assembly according to claim 2, wherein the upper connecting piece is provided with a straight bar stopper on the second through slot; and the straight bar stopper is configured to reduce a contact area between the second through slot of the upper connecting piece and the first protrusion of the lower connecting piece.

7. The floating power supply connecting assembly according to claim 1, wherein the first electric shock connector and the second electric shock connector each comprise an electric shock base and a plug pin; the plug pin is connected to the electric shock base; one end of the first electric shock connector is provided with a second protrusion at the plug pin; one end of the second electric shock connector is provided with a groove at the plug pin; the groove cooperates with the second protrusion, so that the plug pin of the second protrusion is connected to the plug pin in the groove; and a diameter of the plug pin at one end of the first electric shock connector close to the second electric shock connector is greater than a diameter of the plug pin at one end of the second electric shock connector close to the first electric shock connector.

8. The floating power supply connecting assembly according to claim 7, wherein third protrusions are arranged on circumferential walls of the first electric shock connector and the second electric shock connector.

9. The floating power supply connecting assembly according to claim 7, wherein an end portion of the plug pin at one end of the first electric shock connector close to the second electric shock connector is located on the same horizontal plane as an end portion of the first electric shock connector.

10. The floating power supply connecting assembly according to claim 7, wherein positions of the first electric shock connector and the second electric shock connector are interchangeable.
